(19) United States
(12) Patent Application Publication
(10) Pub. No.: US 2004/0170347 A1
(43) Pub. Date: Sep. 2, 2004

(54) Rolling unit

(76) Inventors: Norifumi Ikeda, Kanagawa (JP); Toyohisa Yamamoto, Kanagawa (JP); Kouichi Yamamoto, Kanagawa (JP)

Correspondence Address: Crowell & Moring, PO Box 14300, Washington, DC, 20044-4300, US

(21) Appl. No.: 10/484,076

(22) PCT Filed: Sep. 30, 2002
(86) PCT No.: PCT/JP02/10176

(30) Foreign Application Priority Data
Sep. 28, 2001 (JP) 2001-304,134
Jan. 11, 2002 (JP) 2002-004,981

(51) Int. Cl. F16C 33/32; F16C 33/62

(52) U.S. Cl. 384/492

(57) ABSTRACT

The present invention provides a rolling element capable of ensuring excellent corrosion resistance, and capable of maintaining a stable performance for a long time even in a case where a slight amount of a solution intrudes into the inside, with no occurrence of dry friction and the like between a rolling element and a raceway groove.

For this purpose, the rolling element is comprised of an alumina sintered body with an alumina content of 99.5 mass % or more. The alumina sintered body has a bending strength by a three point bending test according to JIS-R 1601 of 320 MPa or more. The crystal particle constituting the alumina sintered body has an average grain size of less than 2 μm and a ratio of a standard deviation to the average grain size of 0.4 or less. The inner ring and the outer ring are comprised of the alumina sintered body, zirconia sintered body or synthetic resin.

### TECHNICAL FIELD

The present invention concerns a rolling device such as a rolling bearing, a linear guide device and a ball screw device used in a corrosive liquid containing water, a place splashed with such a liquid or a steam-containing corrosive gas, for example, in wafer cleaning apparatus in semiconductor production process or etching apparatus for capacitor films and, more in particular, it relates to a rolling device suitable to application use requiring excellent corrosion resistance and wear resistance.

### BACKGROUND ART

In water or highly corrosive solutions, or in a circumstance exposed to splashing of highly corrosive solutions, since the use of metal materials is difficult, rolling bearings having outer rings, inner rings, and rolling elements composed of ceramic materials are used. For the ceramic materials, silicon nitride, silicon carbide and zirconia are generally used and silicon carbide series ceramics are used, particularly, in application use requiring high corrosion resistance.

As rolling bearings using silicon carbide series ceramics as the material, there have been proposed, for example, those as shown in JP-A No. 10-82426 in which outer rings, inner rings and rolling elements are formed of silicon carbide series ceramic materials and cages formed with a fluoro-resin at least on the surface are incorporated, or those as shown in JP-A No. 2000-9145, in which one of rolling elements and bearing rings is formed of silicon carbide series ceramic material and the other of them is formed of a corrosion resistant metal more excellent in the toughness than the silicon carbide series ceramic material.

By the way, in a case where only a portion of the rolling bearing is dipped in a corrosive solution, or the corrosive solution is splashed only to a portion of the rolling bearing, the amount of the corrosive solution intruded in the rolling bearing is small. Further, at the initial stage of the pump rotation, the rolling bearing is rotated in a state where the amount of the transportation solution is small. Further, also in an application use as in etching apparatus for capacitor films which is used being always immersed in a corrosion solution, the rolling bearing is sometimes rotated while withdrawing the solution during maintenance and it is often rotated in a state where a small amount of solution is intruded in the rolling bearing in the same manner as described above.

However, while the silicon carbide series ceramic generally shows good slidability in the solution, the slidability in a dried state is not so favorable. Particularly, the ceramic material has poor wettability to water when compared with the metal material and, when the amount of the solution in the rolling bearing is reduced to a small amount, dry friction may be sometimes caused partially.

Accordingly, as in a case of the rolling bearing described in JP-A No. 10-82426 in which all the outer ring, the inner ring and the rolling element are formed of the silicon carbide series ceramic, when the rolling bearing is used in a state where a small amount of solution is intruded in the inside, it causes dry friction to possibly generate fluctuation of torque or vibrations, which is attributable to deterioration of bearing life.

Particularly in an application use where a moment load is exerted on the rolling bearing, since the surface pressure between the bearing ring and the rolling element increases, when the dry friction described above is caused, minute injuries are sometimes formed on the raceway surface or the surface of the rolling element to shorten the bearing life.

In view of the above, JP-A No. 2000-9145 describes that the rolling element is composed of a corrosion resistant metal in order to improve the increase of the surface pressure caused by the moment load but, when the rolling element is made of metal, it deteriorates the corrosion resistance of the rolling bearing to bring about a problem that the element can no more be used in the corrosive liquid or corrosive gas described above.

Further, corrosive solutions used, for example, in semiconductor production process can include also an alkaline solution such as ammonium hydroxide in addition to the acidic solution such as hydrochloric acid, sulfuric acid or hydrofluoric acid. Particularly, with an aim of improving the efficiency in the production step, compositions of the chemical solutions to be used have become complicated, which vary depending on respective semiconductor manufacturers in recent years. Accordingly, corrosion resistance to all sorts of liquid chemicals are required also for rolling bearings used in the production facilities described above.

Generally, ceramic materials are classified into basic compounds, acidic compounds and amphoteric compounds having properties between them. While acidic compounds are not attacked by acids, they are inferior in the corrosion resistance to alkaline solutions than the basic compounds. On the contrary, the basic compounds show excellent resistivity to alkaline solutions but they are readily attacked by acidic solutions.

Silicon carbide series ceramics used as materials for the rolling bearing described in each of the publications are highly acidic compounds, and have extremely good corrosion resistance to acids, but their resistivity to the alkaline solutions are not so strong. Accordingly, it has needed a care applying a rolling bearing made of silicon carbide series ceramic to a process using an alkaline solution. Particularly, corrosion resistance of the rolling element to the working atmosphere gives a significant effect on the performance of the bearings.

The present invention has been achieved in order to solve the subject in the prior art and it is an object thereof to provide a rolling device such as a rolling bearing capable of ensuring excellent corrosion resistance, as well as, causing no dry friction between a rolling element and a raceway groove even in a case of use with a slight amount of a solution being intruded in the inside and capable of maintaining stable performance for a long time.

### DISCLOSURE OF THE INVENTION

For attaining the foregoing object, the present invention provides a rolling device at least comprising a first member and a second member having raceway grooves opposed to each other, and a plurality of rolling elements arranged rotatably between the raceway grooves of both of the members in which one of the first member and the second member moves relatively to the other by the rolling of the rolling elements, wherein the first member, the second member and the plurality of rolling elements are formed of ceramic materials, one or more of the plurality of rolling elements comprise an alumina sintered body with an alumina content of 99.5 mass % or more, and a bending strength of the alumina sintered body by a three point bonding test according to JIS R 1601 is 320 MPa or more.

The rolling device is referred to as a first rolling device and detailed description is to be made later.

In the first rolling device, the ceramic material constituting the first member and the second member can include a silicon carbide sintered body, an alumina sintered body, and a zirconia sintered body.

The present invention also provides a rolling device at least comprising a first member and a second member having raceway grooves opposed to each other, and a plurality of rolling elements arranged rotatably between the raceway grooves of both of the members, in which one of the first member and the second member moves relatively to the other by the rolling of the rolling elements, wherein at least one of the first member and the second member is formed of a synthetic resin, one or more of the plurality of rolling elements comprise an alumina sintered body with an alumina content of 99.5 mass % or more, and a bending strength of the alumina sintered body by a three point bonding test according to JIS R 1601 of 320 MPa or more.

The rolling device is referred to as a second rolling device and detailed description is to be made later.

In the rolling device of the present invention (first and second rolling devices), it is preferred that all the plurality of rolling elements are formed of an alumina sintered body with an alumina content of 99.5 mass % or more and a bending strength of the alumina sintered body by the three point bending test according to JIS R 1601 of 320 MPa or more.

In the rolling device of the present invention (first and second rolling devices), the average grain size of the crystal particle constituting the alumina sintered body is preferably less than 2 μm.

This can particularly prevent the progress of wear due to intergranule cracking to extend the life of the rolling device. An alumina sintered body having an average grain size of a crystal particle more preferably of 1 μm or less and, further, more preferably, 0.5 μm or less is used.

In the rolling device (first and second rolling devices) of the present invention, it is preferred that the crystal particle constituting the alumina sintered body has an average grain size of less than 2 μm and the ratio of the standard deviation to the average grain size (value showing scattering of particle) is preferably 0.4 or less. This can further prevent progress of wear caused by intergranule cracking and can extend the life of the rolling device further.

The alumina sintered body with a small average grain size as described above is obtained preferably by using, as a material powder, a fine alumina powder at high purity capable of satisfying all of conditions that the purity (alumina content) is 99.99 mass % or more, central grain particle size of the primary particle is 0.5 μm or less, the grain size for 80% accumulated weight is 0.8 μm or less (preferably, 0.6 μm or less) and conducting sintering at a sintering temperature, for example, of 1300° C. or lower so as not to grow the crystal particles remarkably.

In the rolling device (first and second rolling devices) of the present invention, the surface roughness of the rolling element comprised of the alumina sintered body is preferably 0.02 μm or more and 0.5 μm or less as the center line mean roughness (Ra).

In the rolling device (first and second rolling devices) of the present invention, the alumina sintered body is preferably obtained by pressure sintering method and has a relative density of 99.5% or more.

In the rolling device (first and second rolling devices) of the present invention, it is preferred that the alumina sintered body preferably has a total content of alkali metal elements and alkaline earth metal elements of 500 mass ppm or less and a linear transmittance of a light at 650 nm wavelength for 1 mm thickness of 30% or more. The light transmitting alumina sintered body has high resistance to plasma etching since it contains extremely less light absorbing impurities (mainly alkali metals and alkaline earth metals) and less random portions in atom arrangement (grain boundary, etc.).

(Description on First Rolling Device)

The rolling device of the present invention is identical with a rolling device in which a plurality of rolling elements are arranged between an outer member and an inner member, and one of the outer member and the inner member corresponds to the first member and the other corresponds to the second member.

An example of a rolling device according to the present invention is a rolling device such as a linear guide device in which a plurality of rolling elements are arranged between a guide rail (inner member) and a slider (outer member), a ball screw in which a plurality of rolling elements are arranged between a screw shaft (inner member) and a ball nut (outer member), or a rolling bearing in which a plurality of rolling elements are arranged between an inner ring (inner member) and an outer ring (outer member) and, particularly, a corrosion resistant rolling device required for excellent corrosion resistance and wear resistance in corrosive circumstances, in which the outer member and the inner member are formed of a ceramic material mainly comprising silicon carbide or alumina, and one or more of the plurality of rolling elements is formed of a ceramic material comprising alumina as a main ingredient.

The rolling device can ensure excellent corrosion resistance and prevent occurrence of dry friction between the members to effectively suppress the occurrence of torque-fluctuation or vibrations during rolling and, further, can reduce increase of the surface pressure by load thereby maintaining stable performance for long time.

That is, alumina has corrosion resistance to various acidic solutions and alkaline solutions, equal with or superior to that of silicon carbide and, accordingly, it does not deteriorate the corrosion resistance of the rolling device even when a rolling element comprising an alumina series ceramic material and a rolling element comprising a silicon carbide series ceramic material are used in combination.

Further, since alumina is excellent in a hydrophilic property compared with silicon carbide, when a rolling element of the silicon carbide series ceramic and the rolling element of the alumina series ceramic are incorporated in combination to a rolling device, highly hydrophilic alumina draws the solution to the inside of the rolling device such as a rolling bearing to suppress occurrence of dry friction inside of the device.

Accordingly, this can effectively prevent the problem as the occurrence of torque-fluctuation or vibrations during rolling in a case where all of the outer member, the inner member and the rolling element are formed of the silicon carbide series ceramic material.

In this case, when at least one rolling element of the alumina series ceramic is incorporated between the outer member and the inner member, the state of friction in the inside can be improved and, it is preferred that more than one-half of the whole number of the rolling elements, further preferably, a whole number of the rolling elements are constituted with rolling elements made of the alumina series ceramics. Further, it is preferred to constitute all the outer member, the inner member and the rolling elements with alumina.

Further, when the roughness on the surface of the rolling element made of the alumina series ceramic is defined as 0.02 μm or more, preferably, 0.1 μm or more as the center line mean roughness (Ra), since a solution stagnates in the recesses, the effect of drawing the solution to inside of the device can be improved further in a case of use with a slight amount of the solution.

However, when the surface roughness exceeds 0.5 μm Ra, it may possibly cause injury of the rolling element such as flaking or minute wear of the rolling element starting from the roughness, so that the surface roughness of the rolling element made of the alumina series ceramic material is preferably within a range from 0.02 to 0.5 μm as the center line mean roughness (Ra). Further, since the surface area of the rolling increases as the surface roughness increases to sometimes deteriorate the corrosion resistance, it is preferred to decrease the surface roughness of the rolling element, particularly, to a lower region (for example, about 0.2 μm Ra) among the preferred range described above.

Further, since alumina has a smaller longitudinal modulus of elasticity compared with silicon carbide to provide an effect of moderating the surface pressure at the surface of contact, increase in the surface pressure between the raceway surface and the rolling element can be moderated even when a moment load is loaded on the rolling device.

Further, it is preferred that the material of alumina is sintered by HIP or pressure sintering.

Alumina is an amphoteric compound having a property between the acidic compound and the basic compound and has corrosion resistance to some extent for both the acidic solution and the alkaline solution. However, usual alumina sintered body is mixed with metal oxides such as MgO or SiO₂ as additives and have a property somewhat localized to basic or acidic nature by the effect of the additives. Then, it is necessary to reduce the amount of additives as less as possible in order to provide an excellent property for a wide range of liquid chemicals. That is, it is desirable that the additives are restricted to 0.5% or less, preferably, 0.1% or less.

Further, it has been known that when material defects such as voids or cracks at the surface are present, they generate internal corrosion by the permeation of the solution from the outside to remarkably worsen the corrosion resistance of the material. Particularly, when the material is used, for example, as a rolling element of a rolling bearing, since it is necessary to have an excellent property to repetitive stresses in a corrosion circumstance, it is necessary to decrease not only the material defects on the surface but also the internal defects as small as possible.

In the present invention, with the view point described above, duration life of the rolling bearing can be improved remarkably by using a fine starting alumina powder at high purity and using a material reduced with internal defects by pressure sintering for the alumina sphere used as a rolling element, and a rolling bearing capable of being used stably for a long time in a wide range of corrosive acidic or alkaline circumstances can be obtained.

When the relative density of the alumina sintered body is 99.5% or more, preferably, 99.8% or more, the bearing rotation life can be improved further.

The silicon carbide sintered body used many be an α-type with round crystal grain, or a β-type with elongate crystal grain, and a sintering aid ingredient may be a B-C system or B-C-Al system. Further, in the material comprising the sintered silicon carbide material obtained by reaction sintering, since the metal Si ingredient may sometimes remain inside the material, and this may possibly give undesired effects on the corrosion resistance of the material, it is preferred to restrict the residual Si ingredient to 5% or less.

Also for the sintering method, either HIP or gas pressure sintering or pressureless sintering can be used suitably so long as the three point bending strength of the sintered body is 400 MPa or more.

The alumina sintered body used as the material for the rolling element desirably has a three point bending strength of 320 MPa or more, preferably, 400 MPa or more and, more preferably, 500 MPa or more in order to maintain the load resistance of the bearing.

Further, it is desirable that the total for metal oxides such as SiO₂, NaO₂, Fe₂O₃, MgO and ZrO₂ contained as impurities in the starting alumina powder is 0.5% or less, preferably, 0.3% or less since corrosion resistance can be maintained also for the use in a highly reactive hydrofluoric acid (aqueous HF solution).

Further, when metal ingredients M such as of Fe, Ti, Zn and Mg are mixed in the form of MAl₂O₄ in a matrix, the hydrophilic property is improved desirably and it is also desirable that they are retained within such a range as not giving undesired effects on the corrosion resistance of the sintered body.

In the first rolling device, it is preferred to use a zirconia sintered body constituting the first member and the second member having an Young's modulus of 200 GPa or more and use an alumina sintered body constituting the rolling element having a Young's modulus of 300 GPa or more. More preferably, a zirconia sintered body having a Young's modulus of 250 GPa or more is used and an alumina sintered body having the Young's modulus of 350 GPa is used.

Further, it is preferred to use a zirconia sintered body having a Vickers hardness of 1000 or more and an alumina sintered body having a Vickers hardness of 1500 or more. It is more preferred to use a zirconia sintered body having a Vickers hardness of 1200 or more and an alumina sintered body having a Vickers hardness of 1700 or more.

By constituting the first member and the second member with the zirconia sintered body and the rolling element with the alumina sintered body, more preferred rolling performance can be obtained compared with the case of constituting all the first member, the second member and the rolling element with silicon nitride sintered body, silicon carbide sintered body, zirconia sintered body or alumina sintered body.

{Description for Second Rolling Device}

The synthetic resin used herein can include a polyethylene (PE) resin, a polypropylene (PP) resin, fluoro resin and a corrosion resistant resin capable of melt molding.

The fluoro resin can include, for example, tetrafluoroethylene (PTFE), tetrafluoroethylene-perfluoroalkylene vinyl ether copolymer (PFA), tetrafluoroethylene-hexafluoropropylene copolymer (FEP), polychlorotrifluoroethylene (PCTFE), tetrafluoroethylene-ethylene copolymer (ETFE), chlorotrifluoroethylene-ethylene copolymer (ECTFE), and polyvinylidene fluoride (PVDF). They may be used alone or in combination of two or more of them. Among them, use of PTFE, PFA, ETEE, PVDF or FEP having excellent self-lubricity and corrosion resistance is preferred.

The corrosion resistant resin capable of melt molding can include polyarylene sulfide resins typically represented by polyphenylene sulfide (PPS), polyether ether ketone (PEEK), copolymer of polyether ether ketone and polybenzimidazole (PEEK-PBI), and polyether nitrile (PEN). They may be used alone or in combination of two or more of them. Among them, it is preferred to use PPS or PEEK having excellent self-lubricity and corrosion resistance.

The synthetic resin described above with addition of solid lubricant may also be used. The solid lubricant that can be added can include, for example, powder of polytetrafluoroethylene (PTFE), graphite, hexagonal boron nitride (hBN), fluoro mica, melamine cyanurate (MCA), amino acid compound having layerous crystal structure (N-lauro·L-lysin), fluorinated graphite, fluorinated pitch, molybdenum disulfide and tungsten disulfide. They may be used alone or in combination of two or more of them.

Further, with an aim of improving the mechanical strength, wear resistance and dimensional stability, the synthetic resin described above with addition of fibrous fillers may also be used. The fibrous fillers that can be used can include, for example, aluminum borate whiskers, potassium titanate whiskers, carbon whiskers, alamide fibers, aromatic polyimide fibers, liquid crystal polyester fibers, graphite whiskers, glass fibers, carbon fibers, boron fibers, silicon carbide whiskers, silicon nitride whiskers, alumina whiskers, aluminum nitride whiskers and wollastonite.

Further, the fibrous fillers to be added may be applied with a surface treatment by a silane type or titanate type coupling agent with an aim of improving the adhesion to a resin as a base material or applied with a surface treatment depending on other purpose.

### BRIEF DESCRIPTION OF THE DRAWINGS

FIG. 1 is a schematic cross sectional view showing a rolling bearing as a test bearing used in a rotation test for the evaluation of the present invention.

FIG. 2 is a schematic cross sectional view showing a rotation tester used for examining the performance of each test bearing.

FIG. 3 is a graph showing a relation between the number of rolling elements comprises of alumina sintered body (alumina 5) incorporated in the test bearing and a bearing life ratio.

FIG. 4 is a graph showing a relation between a surface roughness of a rolling element incorporated in the test bearing and a bearing life ratio.

FIG. 5 is a graph showing a relation between a bending strength of a rolling element incorporated in the test bearing and a bearing life ratio.

FIG. 6 is a graph showing the result of a bearing rotation test for examining the corrosion resistance to an aqueous solution of sodium hydroxide (alkaline solution).

FIG. 7 is a graph showing the result of the bearing rotation test for examining the corrosion resistance to an aqueous solution of hydrofluoric acid (acidic solution).

FIG. 8 is a graph showing the result of the bearing rotation test for examining the corrosion resistance to an aqueous solution of sodium hydroxide (alkaline solution), which shows a relation between a relative density of an alumina sintered body constituting a rolling element and a bearing life ratio.

FIG. 9 is a graph showing the result of the bearing rotation test for examining the corrosion resistance to an aqueous solution of sodium hydroxide (alkaline solution), which shows a relation between the number of rolling elements comprised of an alumina sintered body and a bearing life ratio.

FIG. 10 is a graph showing a relation between an average grain size of crystal particle forming an alumina sintered body constituting an inner ring and an outer ring and a total wear volume rate.

FIG. 11 is a graph showing the result of measurement for the total wear volume rate in a case where the average grain size of the crystal particle constituting the alumina sintered body for the inner ring and the outer ring is 1.8 μm, which is a graph showing a relation between the ratio of a standard deviation of the crystal particle constituting the alumina sintered body used relative to the average grain size, and a total wear volume rate.

FIG. 12 is a graph showing a relation between a radial clearance inclement ratio (based on the radial clearance increment of No. 2-16 assumed as “1”) and an average crystal grain size of crystal particles constituting the alumina sintered body for the rolling element in a case of using an inner ring and an outer ring made of a zirconia sintered body (No. 2-12 to No. 2-16).

FIG. 13 is a graph showing a relation between a radial clearance inclement ratio (based on the radial clearance increment of No. 2-21 assumed as “1”) and an average crystal grain size of crystal particle constituting the alumina sintered body for the rolling element in a case of using an inner ring and an outer ring made of a silicon carbide body (No. 2-17 to No. 2-21).

FIG. 14 is a graph showing a relation between a radial clearance inclement ratio (based on the radial clearance increment of No. 2-26 assumed as “1”) and an average crystal grain size of crystal particle constituting the alumina sintered body for the rolling element in a case of using an inner ring and an outer ring made of {PVdF+carbon fiber (15 mass %)} (No. 2-22 to No. 2-26).

FIG. 15 is a graph showing the durability, to 5N hydrochloric acid, of a test bearing manufactured by using an inner ring and an outer ring comprised of an alumina sintered body having a linear transmittance of 30% and a rolling element comprised of an alumina sintered body with linear transmittance being varied in a relation with the linear transmittance.

FIG. 16 is a graph showing the durability, to 5N sodium hydroxide aqueous solution, of a test bearing manufactured by using an inner ring and an outer ring comprised of an alumina sintered body having a linear transmittance of 30% and a rolling element comprised of an alumina sintered body with linear transmittance being varied in a relation with the linear transmittance.

FIG. 17 is a graph showing durability, to hydrofluoric acid, of a test bearing manufactured with a rolling element comprised of alumina sintered bodies of different relative density and an inner ring and an outer ring of a determined density in a relation to the relative density.

FIG. 18 is a graph showing a relation between the Vickers hardness and the durability ratio (rotation life ratio) of zirconia sintered body (▪) constituting an inner ring and an outer ring and Vickers hardness of alumina sintered body (●) constituting a rolling element obtained from test results in a fifth embodiment.

FIG. 19 is a graph showing a relation between the Vickers hardness and the durability ratio (rotation life ratio) of zirconia sintered body (▪) constituting an inner ring and an outer ring and Young's modulus of alumina sintered body (●) constituting a rolling element obtained from test results in a fifth embodiment.

### BEST MODE FOR PRACTICING THE INVENTION

{First Embodiment}

### EXAMPLE 1

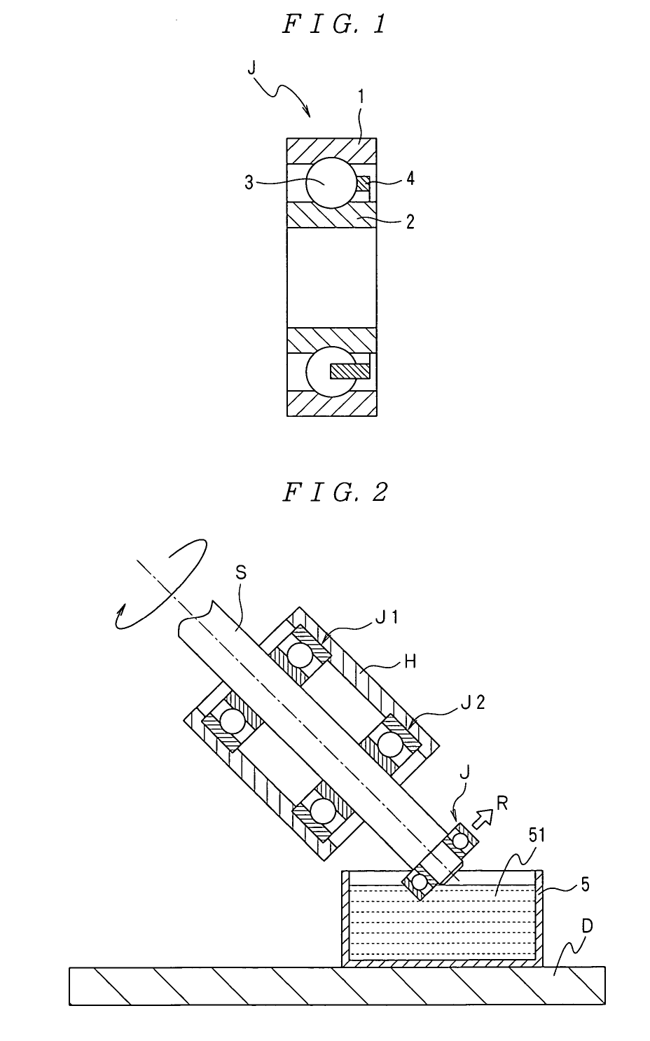

FIG. 1 shows a rolling bearing as a test bearing used in a rotation test for the evaluation of the present invention.

The test bearing J is a ball bearing which is a bearing corresponding to bearing number 6001 (outer diameter: 28 mm, inner diameter: 12 mm, width; 8 mm, number of rolling element; 8) in which a plurality of rolling elements 3 are arranged by way of cages 4 between an outer ring 1 and an inner ring 2.

In this example, by forming the outer ring 1 and the inner ring 2 from a material made of a silicon carbide sintered body shown in Table 1, and forming the rolling element 3 by using a material made of silicon carbide sintered body and materials made of five kinds of alumina sintered bodies of different purity and strength respectively (alumina 1 to 5) also shown in Table 1, to manufacture test bearings J No. 1-1 to No. 1-17 with respective constitutions shown in Table 2. Further, the cage 4 was formed by using a PVDF (polyvinylidene fluoride) resin containing 20 mass % of potassium titanate fibers.

The bending strength in Table 1 is described for the result obtained by conducting a three point bending test according to JIS-R 1601 using test pieces of 36 mm×4 mm×3 mm made of each material at a spun distance of 30 mm. Further, the modulus of elasticity was determined based on the measured value for the amount of displacement by three point bending in accordance with JIS-R 1602 by using test specimens of 36 mm×4 mm×1.5 mm made of each material.

Further, for investigating the corrosion amount of each material, after charging hydrofluoric acid (aqueous hydrogen fluoride solution) at 5 vol % concentration in a vessel made of a fluoro-resin, balls of 9.575 mm diameter made of each material were placed in the vessel and a test of keeping them at 80° C. for 100 hours was conducted.

Then, the corrosion amount was calculated based on the weight reduction for each of the balls before and after the test and the corrosion amount ratio was calculated based on that of alumina 1 assumed as “1”. Further, fracture sections of the alumina materials 1 to 5 were observed by a scanning type electron microscope to measure the average crystal grain size of the sintered body constituting each of the materials. As the material made of the silicon carbide sintered body, an α-type silicon carbide sintered body sintered by using a B (boron)-C (carbon) type sintering aid was used.

Then, for examining the performance of each of the test bearings J of No. 1-1 to No. 1-17, a rotation test was conducted by using a rotation tester shown in FIG. 2.

As shown in FIG. 2, the rotation tester comprises a rotational shaft S disposed obliquely to a horizontal base D, two ball bearings J1 and J2 supporting the rotational shaft S, and a housing H, in which outer rings for both of the ball bearings J1 and J2 are fixed to both axial ends of the housing H. Further, a vessel 5 containing a corrosive solution as liquid 51 is placed on the base D. Upon starting the test, the test bearing J is mounted to the top end of the rotational shaft S (on the side of base D). In this case, the rotational shaft S is disposed such that the outer ring of the test bearing J is dipped into the liquid 51 in the vessel 5.

The test was conducted by rotating the inner ring while applying a load in the radial direction (radial load) R to the test bearing J. Test conditions were set at a radial load of 59N, at a rotational speed of 500 min−¹, at an atmospheric temperature of normal temperature, and in a corrosive solution of 1N hydrochloric acid (aqueous solution of hydrogen chloride).

Vibrations generated to the test bearing J during the test were measured, the rotation was stopped at the timing the vibration value reached twice the value at the start of the test. The rotation time up to this timing was measured and each rotation time was converted into a value based on the rotational time of No. 1-15 assumed as “1”to define the value as a rotation life ratio.

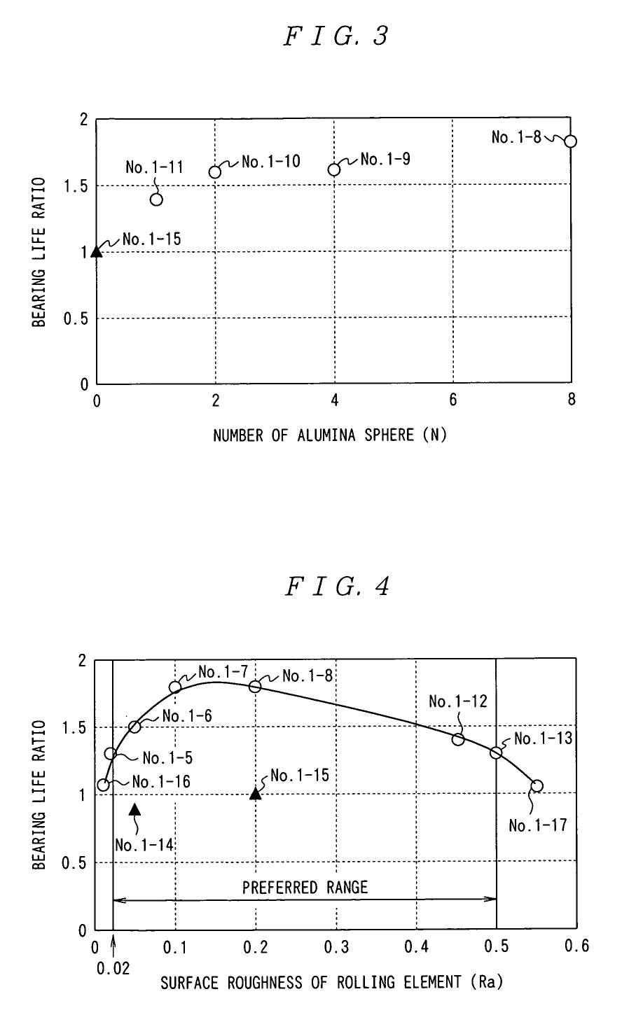

Test results are shown in FIG. 3 to FIG. 5.

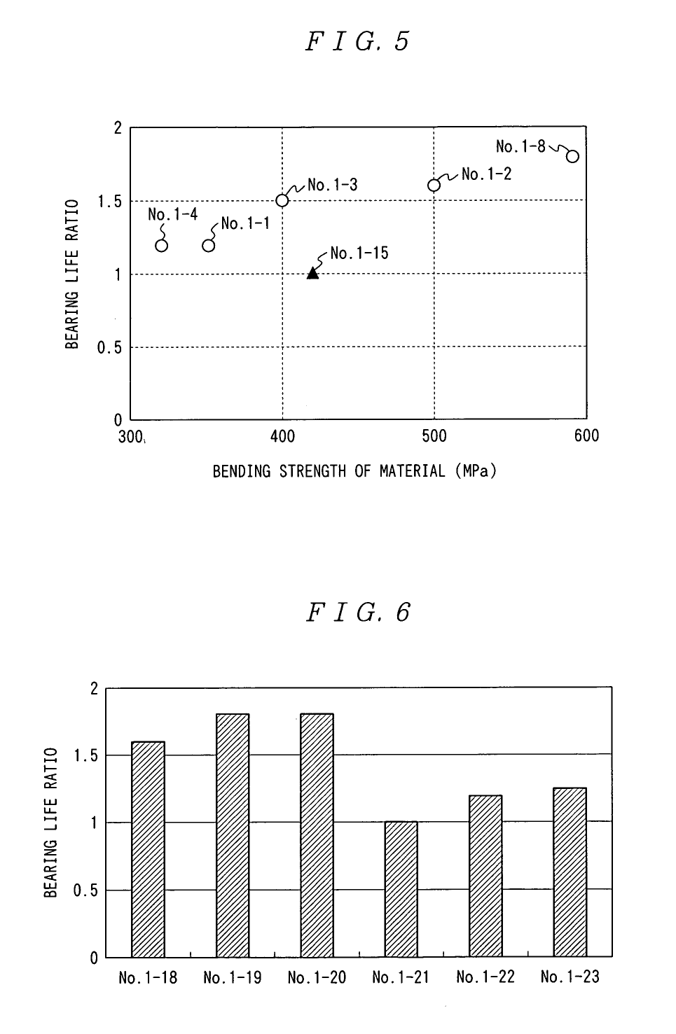

FIG. 3 is a graph showing a relation between the number of rolling elements comprised of an alumina sintered body (alumina 5) incorporated in the test bearing and a bearing life ratio. FIG. 4 is a graph showing a relation between the surface roughness of a rolling element incorporated in the test bearing and the bearing life ratio. FIG. 5 is a graph showing a relation between the bending strength of a rolling element incorporated in the test bearing and the bearing life ratio.

As apparent from FIG. 3, by constituting at least one of rolling elements, among rolling elements by the number of 8, with alumina 5 (alumina sintered body with alumina content of 99.5 mass % and bending strength of 590 MPa), the bearing life ratio increased to 1.4 to 1.8 times compared with a case in which all the rolling elements were comprised of the silicon carbide sintered body (No. 1-15). Particularly, the life was longest in a case of constituting all the rolling elements with alumina 5 (alumina sintered body with alumina content of 99.5 mass % and bending strength of 590 MPa) (No. 1-8).

Further, as shown in FIG. 4, in a case where all the rolling elements were constituted with alumina 5 (No. 1-5 to No. 1-8, No. 1-12, No. 1-13, No. 1-16, No. 1-17), the effect of drawing the solution to the inside of the bearing was improved by defining the surface roughness of the rolling element to 0.02 μm or more and 0.5 μm or less (preferred range) as the center line mean roughness (Ra), to obtain the bearing life 1.3 to 1.8 times that in the case of constituting all the rolling elements with the silicon carbide sintered body (No. 1-15).

Even in a case where all the rolling elements were constituted with alumina 5, if the surface roughness of the rolling element was out of the preferred range described above (No. 1-16, No. 1-17), it had a life ratio somewhat greater than the case of constituting all the rolling elements with the silicon carbide sintered body (No. 1-15).

Further, as shown in FIG. 5, the bearing life ratio tended to increase in proportion with the bending strength. Particularly, when the bending strength of the alumina material was 400 MPa or more (No. 1-2, No. 1-3, No. 1-5), bearing rotated for a long time with no increase of vibrations.

In No. 1-1 to No. 1-4, and No. 1-8, since all the rolling elements was constituted with alumina 5, they obtained more excellent life characteristics than No. 1-15 in which all the rolling element were constituted with silicon carbide sintered body.

### EXAMPLE 2

Like Example 1, ball bearings corresponding to bearing No. 6001 were used as test bearings.

In the example, outer ring 1, inner ring 2 and rolling element 3 were formed by using the material made of silicon carbide sintered body, and materials made of four kinds of alumina sintered bodies of different material powders or sintering methods (alumina 6-9) shown in Table 3, and test bearings J of No. 1-18 to No. 1-23 were manufactured with each of the constitutions shown in Table 4. All the rolling elements 3 by the number of 8 in each of the test bearings had an identical constitution.

The surface roughness of the rolling element was defined to about 0.04 μm as the center line mean roughness (Ra). As the material made of the silicon carbide sintered body, α-type silicon carbide sintered body sintered by using B (boron)-C (carbon) type sintering aid was used. The cage 4 was formed by using a PVDF (polyvinylidene fluoride) resin containing 20 mass % of potassium titanate fibers.

Then, for examining the performance of each of the test bearings J of No. 1-18 to No. 1-23, a rotation test was conducted like Example 1 by using the rotation tester shown in FIG. 2.

However, a vessel 5 containing ion exchanged water as liquid 51 was placed on the base D. Further, after dipping in a 5 mass % hydrofluoric acid (aqueous hydrogen fluoride solution) controlled to a temperature of 80° C., or 30 mass % aqueous NaCl solution controlled to a temperature of 80° C., for 100 hours, each of the test bearings J was mounted to the rotational shaft of the rotation tester.

Then, the test was conducted by rotating the inner ring while applying a load in the radial direction (radial load) R to the test bearing J. Test conditions were set at radial load of 98N, at a rotational speed of 500 min⁻¹, and at an atmospheric temperature of normal temperature.

Vibrations generated to the test bearing J during the test were measured, the rotation was stopped at the timing the vibration value reached a value twice the that at the start of the test. The rotation time up to this timing was measured and each rotational time was converted into a value based on the rotational time of No. 1-21 assumed as “1” to define the value as a rotation life ratio.

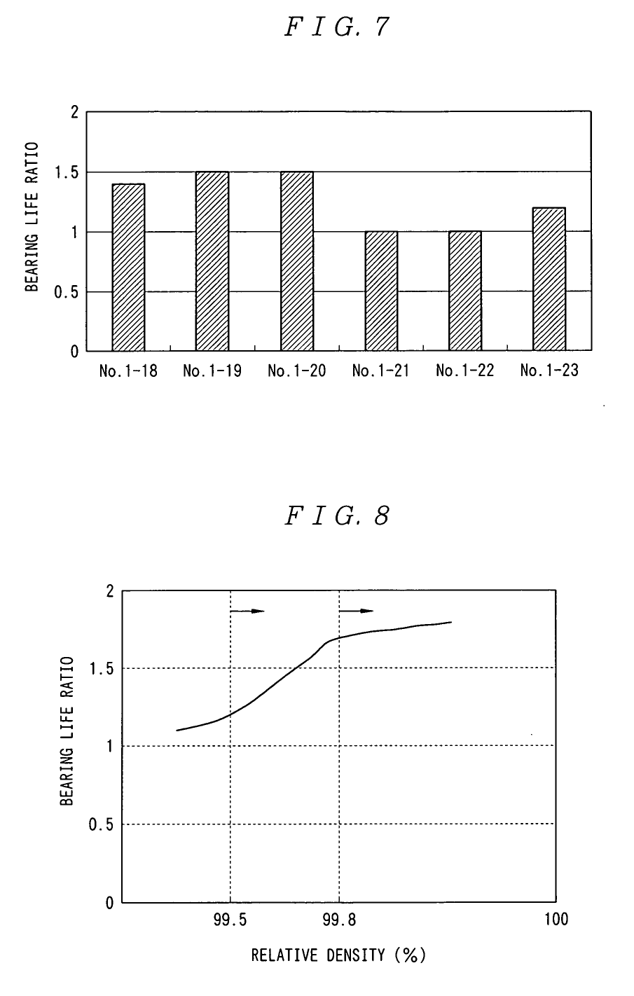

FIG. 6 shows a result in a case of dipping into an aqueous solution of sodium hydroxide (alkaline solution) before the rotation test. FIG. 7 shows a result in a case of dipping into hydrofluoric acid (acidic solution) before the rotation test.

As apparent from FIG. 6, when the rotation test was conducted after dipping into the alkaline solution, in a case where the rolling element incorporated into the test bearing was alumina sintered body (No. 1-18 to No. 1-20, No. 1-22, No. 1-23), more preferred rotation life was obtained than in the case where the rolling element incorporated in the test bearing was made of a silicon carbide sintered body (No. 1-21) (1.2 times or more). Particularly, in No. 1-18 to No. 1-20 using the alumina sintered body obtained by pressure sintering method (alumina 8 and alumina 9), rotation life of 1.6 to 1.8 times that of No. 1-21 was obtained.

Among the test bearings in which the rolling elements incorporated therein were made of alumina sintered body, No. 1-18 to No. 1-20 using the alumina sintered bodies obtained by pressure sintering (alumina 8 and alumina 9) obtained more preferred rotation life than that of No. 1-22 and No. 1-23 using alumina sintered bodies obtained by pressureless sintering method (alumina 62 and alumina 7). In the test bearing of No. 1-20, all the inner ring, the outer ring and the rolling element were constituted with alumina 9 obtained by pressure sintering.

When the rotation test was conducted after dipping into the acidic solution, in a case where the rolling elements incorporated in the test bearing were alumina sintered bodies (No. 1-18 to No. 1-20, No. 1-22, No. 1-23), equal or superior rotation life was obtained compared with a case where the rolling element incorporated in the test bearing was made of silicon carbide sintered body (No. 1-21) as shown in FIG. 7. Particularly, in No. 1-18 to No. 1-20 using the alumina sintered bodies obtained by pressure sintering (alumina 8 and alumina 9), rotation life of 1.4 to 1.5 times that of No. 1-21 was obtained.

Then, plural kinds of rolling elements comprised of alumina sintered bodies of different relative density were formed, and plural kinds of test bearings of the structure identical with that of FIG. 1 were manufactured by using the inner ring and the outer ring made of silicon carbide and using the rolling elements by the number of 8 made of alumina sintered body of an identical relative density. Using the test bearings described above, a rotation test was conducted in the same manner as described above after dipping into the sodium hydroxide aqueous solution. The result is shown in FIG. 8. The bearing life ratio was calculated based on the rotation time of No. 1-21 assumed as “1”.

As apparent from FIG. 8, the bearing rotation life is improved when the relative density of the alumina sintered body is increased to 99.5% or more and the bearing rotation life is further improved when it is increased to 99.8% or more.

Then, test bearings were manufactured with the number of rolling elements made of alumina 9 being varied from 1 to 7 in the same constitution as that of No. 1-19. As the rolling element other than that made of alumina 9, rolling elements made of the silicon carbide sintered body shown in FIG. 3 was provided and incorporated.

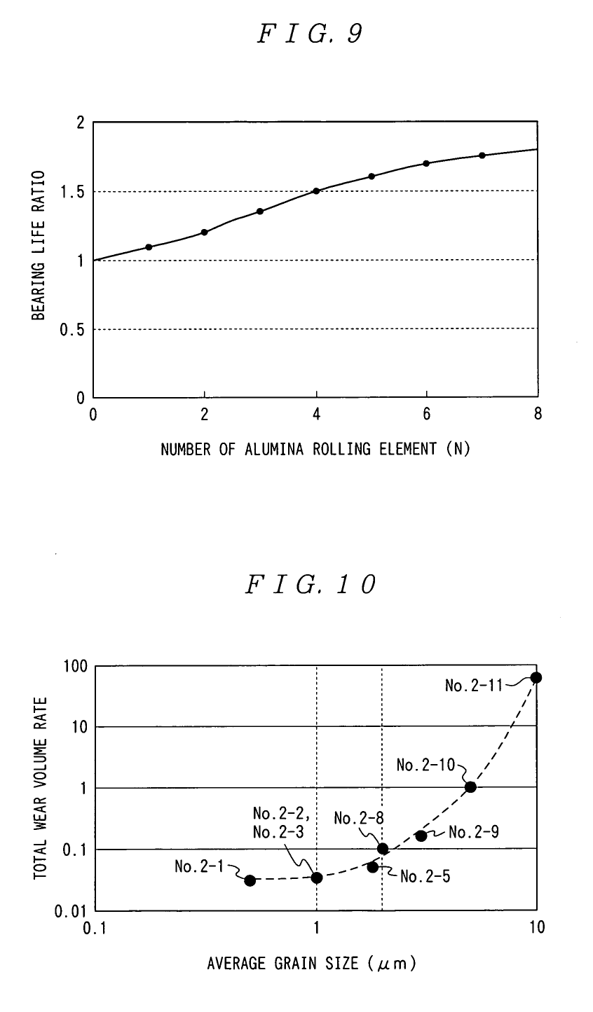

Using the test bearings described above, after immersing them into an aqueous sodium hydroxide solution, a rotation test was conducted. The result is shown in FIG. 9. The bearing life ratio was calculated based on the rotation life of No. 1-21 (number of rolling elements made of alumina 9 being 0) assumed as “1”.

As apparent from FIG. 9, the rotation life of the rolling bearing is improved by incorporating at least one rolling element made of alumina 9 (alumina sintered body with alumina content of 99.9 mass %, relative density of 99.8% and average crystal grain size of 0.5 μm), the rotation life of the rolling bearing is improved and, particularly long rotation life is obtained by making all the rolling elements with alumina 9.

{Second Embodiment}

Like the first embodiment, ball bearings corresponding to bearing No. 6001 were used as test bearings.

In this embodiment, outer ring 1, inner ring 2 and rolling element 3 were formed by using materials of 11 kinds of alumina sintered bodies of different material powders (alumina 11-21) shown in Table 5, silicon carbide identical with that in the first embodiment, PVdF+carbon fiber (15 mass %) identical with that in a fourth embodiment to be described later, and zirconia (Young's modulus 210: GPa, Vickers hardness: 1000) identical with that in the fifth embodiment to be described later, test bearings J of No. 2-1 to 2-26 were manufactured each in the constitution shown in Table 6. In each of the test bearings, all the rolling elements by the number of 8 had the identical constitution.

The material made of the alumina sintered body was prepared by the following method. At first, primary particles as the material powder were pelletted to obtain secondary particles of about 50 to 200 μm. They were placed in a die and molded by a monoaxial pressing method to obtain spherical or ring-shaped molding products. Then, the molding products were charged in an atmospheric furnace and applied with a degreasing treatment at 600° C. Then, they were baked being charged in a separate atmospheric furnace. In the baking step, the grain size of the sintered body was controlled by changing the processing temperature and the processing time. Sintered bodies were obtained by sintering the molding products after baking by an HIP method.

Further, the crystal grain size distribution of crystal particles constituting the sintered bodies of each material was measured as described below.

At first, an arbitrary surface for each of the obtained sintered bodies was subjected to mirror-lapping. Then, they were placed in an electrical furnace and thermally etched at 1100° C. for 30 to 60 min. Then, the lapped surface was provided with conductivity by platinum coating, and the state of crystal particles was observed under a scanning type electron microscope.

Then, arbitrary five view fields within the plane were photographed at 5000×, and image data were introduced into a personal computer for image analysis. A crystal grain boundary was extracted by image analysis to determine the area for each of the crystal particles, and a diameter of a circle having an equivalent area was calculated and the diameter was defined as the particle diameter of the crystal particle (circle-equivalent diameter). The procedures were conducted for five view fields to calculate the entire average grain size and the standard deviation.

The bending strength measured by the same method as in the first embodiment was 320 MPa or more for any of alumina 11-21. Further, the surface roughness of the rolling element was defined to about 0.04 μm as the center line mean roughness (Ra). The cage 4 was formed by using a PVDF (polyvinylidene fluoride) resin containing 20 mass % of potassium titanate fibers.

Then, for examining the performance of each of the text bearings J of No. 2-1 to No. 2-26, a rotation test was conducted by using the rotation tester shown in FIG. 2 in the same manner as in the first embodiment.

However, a vessel 5 containing ion exchanged water as liquid 51 was placed on the base D. For No. 2-1 to No. 2-11, and No. 2-17 to No. 2-26, after dipping into 5 mass % hydrofluoric acid controlled to a temperature 80° C. for 100 hours, each of the test bearings J was attached to the rotational shaft of the rotation tester. For No. 2-12 to No. 2-16, after dipping in 1N hydrochloric acid for 100 hours, each of the test bearings J was attached to the rotational shaft of the rotation tester.

Then, a test was conducted by rotating the inner ring while applying a load in the radial direction (radial load) R to the test bearing J. Test conditions were at a radial load of 98N, at a rotation speed of 500 min⁻¹, at an atmospheric temperature of normal temperature, and for a test time of 100 hrs.

For No. 2-1 to No. 2-11, a groove shape was measured using a surface roughness gauge at arbitrary three points on an arc forming raceway grooves for the outer ring and the inner ring before starting (before incorporation into bearing) and after completion (after decomposition of bearing) of the test. The difference of the measured value before and after the test was calculated on every position and defined as a worn area at each of the positions. The worn volume for the raceway surface of the outer ring and the inner ring was calculated by integrating the average value of the worn area at three positions within a range of the arc. The sum for the worn volume of the outer ring and the inner ring was calculated as a total wear volume.

The total wear volume for each of the test bearings was converted into a value based on the value for No. 2-10 assumed as “1” and the value was defined as a total wear volume rate. The result is shown in FIG. 10. In the graph, the ordinate represents the total wear volume rate, while the abscissa represents the average grain size of crystal particles comprised of the alumina sintered body for the inner ring and the outer ring for each of the test bearings. Both of the ordinate and the abscissa are indicated as logarithmic axis.

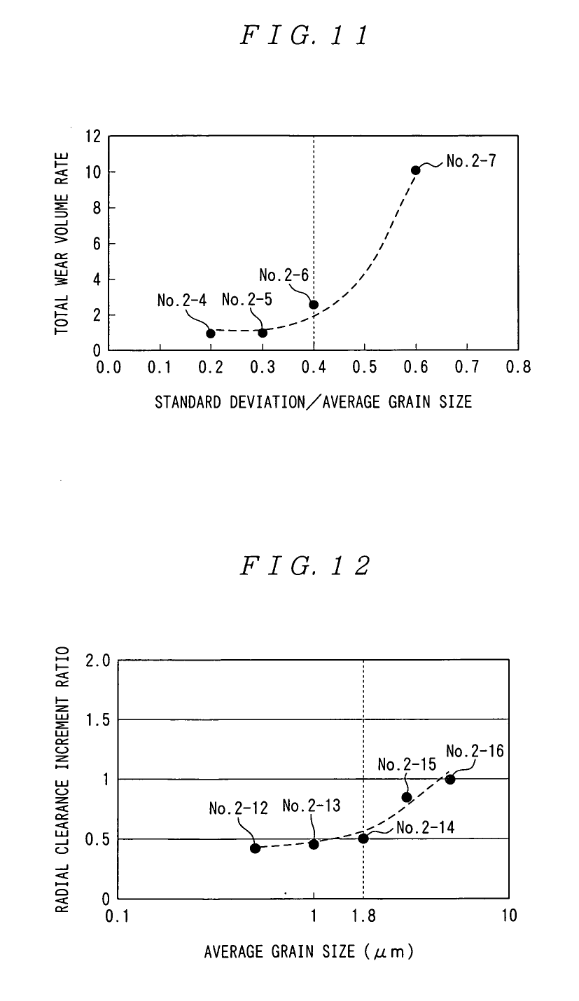

FIG. 11 shows the result of measurement for the total wear volume rate, for No. 2-4 to No. 2-7 in which the average grain size of crystal particles constituting the alumina sintered body for the inner ring and the outer ring is 1.8 μm. The figure is a graph showing a relation between the ratio of the standard deviation to the average grain size of the crystal particle and the total wear volume rate.

For No. 2-12 to No. 2-26, a radial clearance in the direction of applying a load was measured before starting (after assembling into bearing) and after completion (before decomposition of bearing) of the test, and the difference between them (radial clearance increment) was calculated as a value showing the wear amount. The results are shown collectively as graphs in FIG. 12 to FIG. 14 on every materials for the inner ring and the outer ring.

FIG. 12 is a graph showing a relation between a radial clearance inclement ratio (based on the radial clearance increment of No. 2-16 assumed as “1”) and an average crystal grain size of crystal particles constituting the alumina sintered body for the rolling element in a case of using an inner ring and an outer ring made of a zirconia sintered body (No. 2-12-No. 2-16).

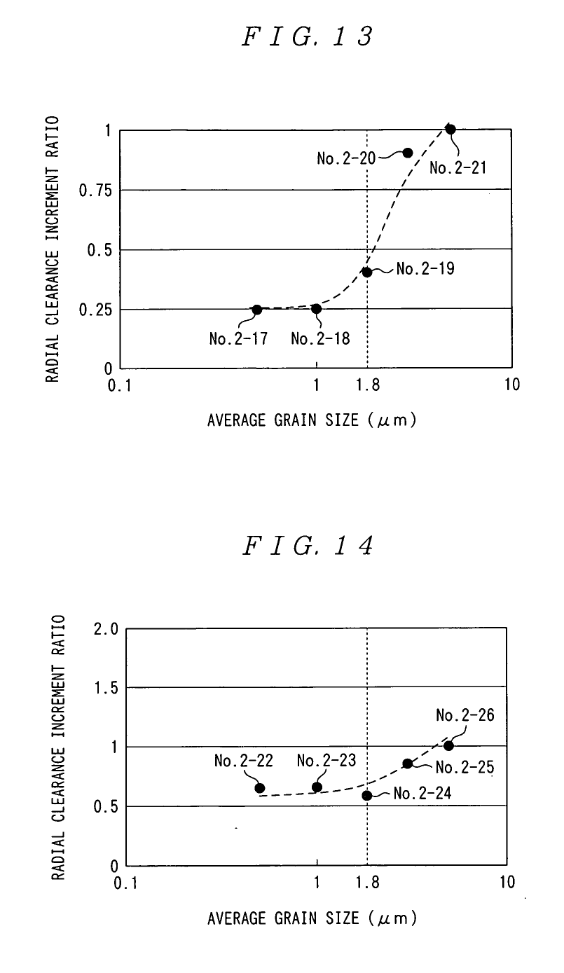

FIG. 13 is a graph showing a relation between a radial clearance inclement ratio (based on the radial clearance increment of No. 2-21 assumed as “1”) and an average crystal grain size of crystal particles constituting the alumina sintered body for the rolling element in a case of using an inner ring and an outer ring made of a silicon carbide body (No. 2-17-No. 2-21). FIG. 14 is a graph showing a relation between a radial clearance inclement ratio (based on the radial clearance increment of No. 2-26 assumed as “1”) and an average crystal grain size of crystal particles constituting the alumina sintered body for the rolling element in a case of using an inner ring and an outer ring made of {PVdF+carbon fiber (15 mass %)} (No. 2-22-No. 2-26).

As can be seen from FIG. 10, when the average grain size of crystal particles constituting the alumina sintered body for the inner ring and the outer ring is decreased to less than 2 μm (1.8 μm or less in this case), the wear amount can be decreased remarkably compared with the case where the average grain size is 2 μm or more. Further, there is no substantial difference between the case where the average grain size is 1 μm and a case where it is 0.5 μm.

As can be seen from FIG. 11, when the alumina sintered body constituted with crystal particles with the ratio described above of 0.4 or less is used for the inner ring and the outer ring, the total wear volume rate can be decreased remarkably compared with the case of using those constituted with crystal particles with the ratio of 0.6, and the total wear volume rate can be decreased particularly by using those constituted with the crystal particles with the ratio of 0.3 or less.

As can be seen from FIGS. 12 to 14, in a case where the inner ring and the outer ring are made of silicon carbide, PVdF+carbon fibers (15 mass %) or zirconia, when the average grain size of the crystal particles constituting the alumina sintered body for the rolling element is decreased to less than 2 μm (1.8 μm or less in this case), the wear amount (radial clearance increment) can be decreased remarkably compared with the case where the average grain size is 2 μm or more.

In the embodiment, while the molding product as the material for the inner ring and the outer ring has been formed by the monoaxial pressing method, it may be formed also by a CIP method. In a case of forming a molding product by the CIP method, a fabrication according to the sample shape is necessary after formation. The molding product obtained by applying the monoaxial pressing method and then further applying processing by the CIP method is preferred since the internal density is made uniform. Further, the spherical body as the material for the rolling element was also conducted by a monoaxial pressing method but use of a molding method by rolling pelletization is preferred since it is excellent in the mass productivity and a spherical body of uniform internal density can be obtained.

{Third Embodiment}

Like the first embodiment, ball bearings corresponding to bearing No. 6001 were used as test bearings.

In this embodiment, outer ring 1, inner ring 2 and rolling element 3 were formed by using a material comprising an alumina sintered body, a material comprising a silicon nitride sintered body and a material comprising a silicon carbide sintered body, and test bearings J of No. 3-1 to No. 3-10 were manufactured with each of the constitutions shown in Table 7. All the rolling elements by the number of 8 for each of the test bearings had an identical constitution. In table 7, the alumina sintered body was indicated as Al₂O₃, the silicon nitride sintered body was indicated as Si₃N₄ and the silicon carbide sintered body was indicated as SiC.

The material comprising the alumina sintered body was prepared by the following method. At first, an α-alumina powder was used as the main starting material to which were added magnesium oxide and yttrium oxide as sintering aids to obtain a powder mixture, and the powder mixture was mixed with a solvent, an organic binder, a plasticizer and a dispersant to obtain a slurry. Then, the slurry was molded into a spherical or ring-like shape, the resultant molding product was baked in atmospheric air and then further baked in a reducing atmosphere to form a sintered body.

Since the particle arrangement in the molding product becomes uniform by the use of the α-alumina powder, uniform crystallization is attained even when the amount of the sintering aid is small. Thus, compared with the case of using an alumina powder other than the α-alumina powder, the addition amount of the sintering aid (for example, magnesium as an alkaline earth metal) can be decreased.

Then, a plasma etching treatment was applied to the outer ring 1, the inner ring 2 and the rolling element 3 constituted with each of the materials. In the plasma etching treatment, a sulfur hexafluoride gas was introduced in a plasma etching apparatus under the conditions at a gas flow rate of 150 SCCM, and at a gas pressure of 1.5 Torr to form a sulfur hexafluoride gas atmosphere in the apparatus, in which the outer ring, the inner ring and the rolling element were placed and plasma etching was conducted for 10 hours under the condition at a microwave power of 350 W.

Those not applied with the plasma etching treatment were also provided as the outer ring 1, the inner ring 2 and the rolling element 3 constituted with the alumina sintered body, as well as the outer ring 1 and the inner ring 2 constituted with the silicon carbide sintered body.

Further, the material comprising alumina sintered body was applied with mirror lapping by using a diamond slurry to prepare a disk-like pellet of 1.00 mm thickness, and a linear transmittance of a light at a wavelength of 650 nm was measured by using the pellet. “UV-1200” manufactured by Shimazu Seisakusho was used as the measuring apparatus.

The bending strength measured by same method as in the first embodiment was 320 MPa or more also in the alumina sintered body used in this embodiment. Further, the surface roughness of the rolling element was defined to about 0.04 μm as the center line mean roughness (Ra). The cage 4 was formed by using a PVDF (polyvinylidene fluoride) resin containing 20 mass % of potassium titanate fibers.

Then, for examining the performance for each of the test bearings J of No. 3-1 to No. 3-10, a rotation test was conducted by using the rotation tester shown in FIG. 2 like in the first embodiment. However, a vessel 5 containing 5N hydrochloric acid (aqueous HCl solution) as liquid 51 was placed on the base D. A test was conducted by rotating the inner ring while applying a load in the radial direction (radial load) R on the test bearing J. The test conditions were at a radial load of 196N, at a rotation speed of 300 min⁻¹ and at an atmospheric temperature of normal temperature.

Then, a test similar to that described above was conducted for each of the test bearings J of No. 3-1 to No. 3-10. The test was different from the method described above only in using a 5N aqueous solution of sodium hydroxide (NaOH) as liquid 51 charged in the vessel 5.

Vibrations generated to the test bearings J during each test were measured and the rotation was stopped at the timing the vibration value reached twice the value at the start of the test, the rotation time up to the timing was examined, each of the rotation time was converted into a value based on the rotation time of No. 3-7 assumed as “1” and the value was defined as the duration ratio (rotation life ratio). The result is shown in Table 7.

The plasma etched sintered body described above tends to be corroded at the portion of impurity particles or grain boundaries tending to form defects (pores or cracks). Further, when the sintered body with defects is dipped in an acid or alkaline solution, the defect portions tend to be eroded preferentially. Accordingly, the durability of the rolling bearing due to the plasma etching resistance of the sintered body can be recognized by the test described above.

From the result in Table 7 it can be seen that durability to acid and alkali is improved when the total content of the alkali metal elements and alkaline earth metal elements is 500 mass ppm or less, and the linear transmittance of a light at a wavelength of 650 nm for 1 mm thickness is 30% or more in the alumina sintered body for the rolling element. Further, it can be seen that when both of the conditions are satisfied, there is no difference of the durability to acid and alkaline between a case of applied with plasma etching treatment and a case not applied with the treatment.

Further, it can be seen that no sufficient effect can be obtained for the improvement of the durability to acid and alkaline for the alumina sintered body for the rolling element even when the total content for the alkali metal elements and the alkaline earth metal elements is 500 mass ppm or less, if the linear transmittance of a light at a wavelength of 650 nm for 1 mm thickness is less than 30% as in No. 3-10.

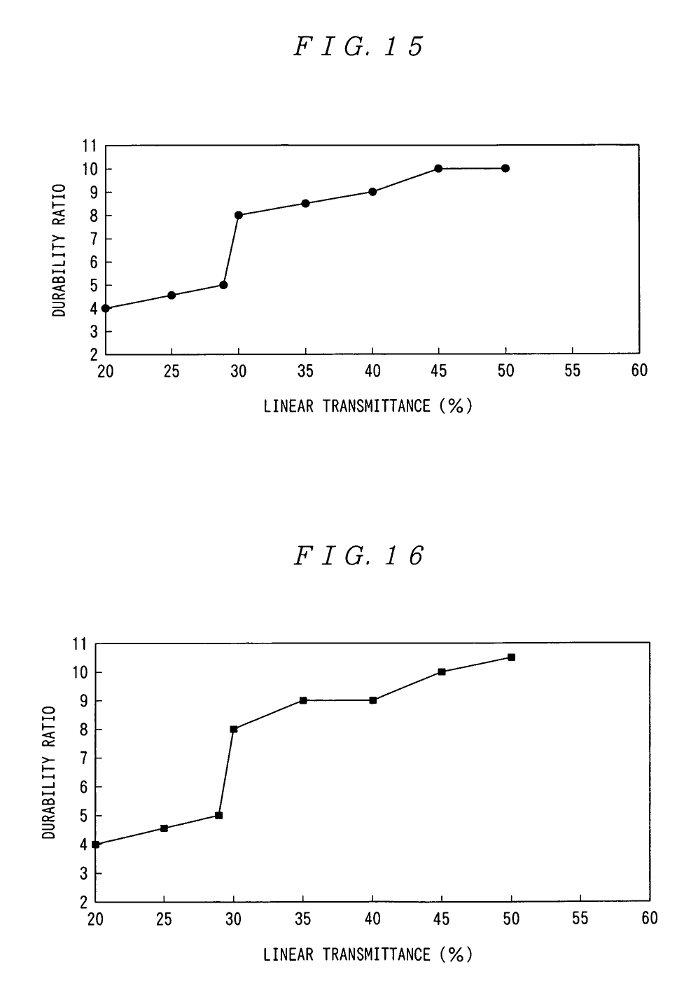

Further, a plurality of test bearing J were manufactured by using those identical with No. 3-3 (comprising alumina sintered body with 30% linear transmittance) as the inner ring and the outer ring and using those comprising alumina sintered bodies with the linear transmittance being varied in a range from 25 to 50% as the rolling element, and the two kinds of tests described previously were conducted for the test bearings. The results are shown in FIG. 15 and FIG. 16 as graphs. Also for the results, the durability ratio based on the data for No. 3-7 assumed as “1” was adopted.

FIG. 15 is a graph showing the durability to 5N hydrochloric acid and FIG. 16 is a graph showing the durability to a 5N aqueous solution of sodium hydroxide. As can be seen from both of the figures, when the linear transmittance of the alumina sintered body for the rolling element is 30% or more, durability to acid and alkali is remarkably improved compared with the case where the rate is less than 30%.

As in the rolling bearing manufactured in this embodiment, the rolling device using, as the alumina sintered body for the rolling element, those having the total content of the alkali metal elements and the alkaline earth metal elements of 500 mass ppm or less and a linear transmittance of a light at a wavelength of 650 nm for 1 mm thickness of 30% or more is improved in the durability to acid, alkali, halogen gas or ion plasma compared with the case of using the alumina sintered body not satisfying the conditions described above, silicon nitride sintered body, silicon carbide sinterded body or zirconia sintered body.

{Fourth Embodiment}

Like the first embodiment, ball bearings corresponding to bearing No. 6001 were used as test bearings. In this embodiment, test bearings J of No. 4-1 to No. 4-8 were manufactured with each constitution shown in Table 8. Rolling elements 3 were formed by using a material comprising an alumina sintered body (alumina 8, 9 in Table 1) and a material comprising a silicon nitride sintered body. Outer ring 1 and inner ring 2 were prepared by using the materials shown in able 8 on every test bearings (synthetic resin or synthetic resin with addition of fibrous filler). All the rolling elements 3 by the number of 8 had an identical constitution in each of the test bearings. In Table 8, “% ” means “mass %”.

As the synthetic resin and the fibrous filler those shown below were used.

PE: “SUNTEC-HDJ310”, manufactured by Asahi Kasei Co.

PVDF: “KUREHA KF POLYMER-T-#850”, manufactured by Kureha Chemical Industry Co.

PPS: “LITON R-6”, manufactured by Philips Petroleum Co.

PEEK: “VICTOLEX PEEK 150G”, manufactured by Victolex Co.

PEN: “RF”, manufactured by Idemitsu Material Co.

Carbon fiber: “KUREKACHOP M-102S”, manufactured by Kureha Kagaku Industry, average fiber diameter; 14.5 μm, length 0.2 μm.

Potassium titanate whisker (KTW): “TISMO D-101”, manufactured by Otsuka Kagaku, average fiber diameter: 0.3 to 0.6 μm, length: 10 to 20 μm

The bending strength measured by the same method as in the first embodiment was 320 MPa or more also in the alumina sintered body used in this embodiment. Further, the surface roughness of the rolling element was defined to 0.05 μm as the center line mean roughness (Ra). Further, as the material comprising the silicon nitride sintered body, those sintered with addition of Al₂O₃, Y₂O₃, etc. as a sintering aid and under a pressure of 10 atm or less were used. Further, the cage 4 was formed by using a PVDF (polyvinylidene fluoride) resin containing 20 mass % of potassium titanate fibers.

Then, for examining the performance of each of the test bearings J of No. 4-1 to No. 4-8, a rotation test was conducted by using the rotation tester shown in FIG. 2 like in the first embodiment.

However, a vessel 5 containing ion exchanged water as liquid 51 was placed on the base D. Further, after dipping in a 5 mass % hydrofluoric acid controlled to a temperature of 50° C. for 240 hours, each of the test bearings J was attached to the rotational shaft of the rotation tester.

Then, the test was conducted by rotating the inner ring while applying a load in the radial direction (radial load) R to the test bearing J. The test conditions were at a radial load of 30N, a rotation speed of 1000 min⁻¹, and at an atmospheric temperature of normal temperature.

Vibrations generated in the test bearing J during the test were measured, and the rotation was stopped at the timing when the vibration value reached three times that at the start of the test, the rotation time up to the timing was examined, each rotation time was converted into a value based on the rotation time of No. 4-8 assumed as “1”, and the value was defined as a rotation life ratio. The result is shown in Table 8.

As can be seen from the result in Table 8, rolling bearings incorporated with rolling elements made of alumina 8 (alumina sintered body with alumina content: 99.5 mass %, relative density: 99.5% and average crystal grain size: 40 μm) and aluminum 9 (alumina sintered body with alumina content: 99.9 mass %, relative density: 99.8% and average grain size: 0.5 μm) can obtained higher durability (longer rotation life) than those of rolling bearings incorporated with rolling elements comprising a silicon nitride sintered body.

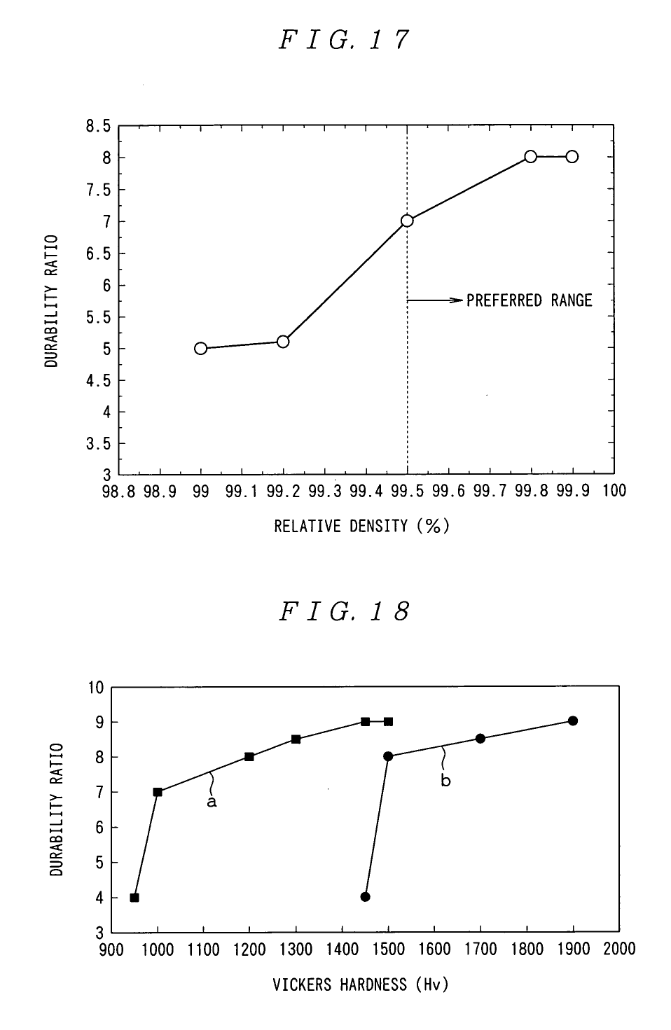

Then, plural kinds of test bearings of the structure identical with that in FIG. 1 were manufactured by forming plural kinds of rolling elements comprising alumina sintered bodies of different relative density and by using an inner ring and an outer ring of the constitution identical with that of No. 4-3 and rolling elements by the number of 8 comprising alumina sintered body of an identical relative density. By using the test bearings, after immersing in the same manner as described above in hydrofluoric acid, a rotation test was conducted. The result is shown in FIG. 17 as a graph. The bearing life ratio was calculated based on the rotation time of No. 4-8 assumed as “1”.

As can be seen from FIG. 17, when the rolling element comprising the alumina sintered body with a relative density of 99.5% or more is used, durability (bearing rotation life) in a corrosive circumstance is remarkably improved, and the bearing rotation life in the corrosive circumstance is improved further by using the rolling element comprising the alumina sintered body with a relative density of 99.8% or more.

{Fifth Embodiment}

The first embodiment, ball bearings corresponding to bearing No. 6001 were used as test bearing.

In this embodiment, outer ring 1, inner ring 2 and rolling element 3 were formed by using a material comprising an alumina sintered body, a material comprising a silicon nitride sintered body and a material comprising a silicon carbide sintered body, and test bearings J of No. 5-1 to No. 5-9 were manufactured with each of the constitutions shown in Table 9. All the rolling elements by the number of 8 for each of the test bearings had the identical constitution. In table 9, the alumina sintered body was indicated as Al₂O₃, the silicon nitride sintered body was indicated as Si₃N₄ the silicon carbide sintered body was indicated as SiC.

The material comprising the alumina sintered body was prepared by the following method. At first, an α-alumina powder was used as the main starting material to which were added magnesium oxide and yttrium oxide as sintering aids to obtain a powder mixture, and the powder mixture was mixed with a solvent, an organic binder, a plasticizer and a dispersant to obtain a slurry. Then, the slurry was molded into a spherical or ring-like shape, the resultant molding product was baked in atmospheric air and then further baked by an HIP method to form a sintered body.

The material comprising the zirconia sintered body was prepared by the following method. At first, a zirconia powder as a main starting material was used and a solvent, an organic binder, a plasticizer and a dispersant were mixed with the powder to obtain a slurry. Then, the slurry was molded into a spherical or ring-like shape. The molded product was sintered at 1400 to 1600° C.

The bending strength measured by same method as in the first embodiment was 320 MPa or more also in the alumina sintered body used in this embodiment. Further, the alumina content of the alumina sintered body used in this embodiment was 99.5% or more. Further, the surface roughness of the rolling element was defined to about 0.04 μm as the center line mean roughness (Ra). The cage 4 was formed by using a PVDF resin containing 20 mass % of potassium titanate fibers.

Then, for examining the performance for each of the test bearings J of the No. 5-1 to No. 5-7, a rotation test was conducted by using the rotation tester shown in FIG. 2 like in the first embodiment. However, a vessel 5 containing 1N hydrochloric acid (aqueous HCl solution) as liquid 51 was placed on the base D. A test was conducted by rotating the inner ring while applying a load in the radial direction (radial load) R on the test bearing J. The test conditions were at a radial load of 196N, at a rotation speed of 300 min⁻¹, and at an atmospheric temperature of normal temperature.

Then, a test similar to that described above was conducted for each of the test bearings J of No. 5-1 to No. 5-7. The test was different from the method described above only in using a 1N aqueous solution of sodium hydroxide (NaOH) as liquid 51 charged in the vessel 5.

Vibrations generated to the test bearings J during each test were measured, and the rotation was stopped at the timing that the vibration value reached twice the value at the start of the test, the rotation time up to the timing was examined, each of the rotation time was converted into a value based on the rotation time of No. 5-7 assumed as “1” and the value was defined as duration ratio (rotation life ratio). The result is shown in Table 9.

From the result of Table 9, it can be seen that the rolling bearings having rolling elements formed of the alumina sintered body (No. 5-1 to No. 5-4, No. 5-6) are more preferred in the durability to acid and alkali than the rolling bearings having the inner ring, the outer ring and the rolling element formed of the silicon nitride sintered body (No. 5-7). Further, the rolling bearings having the inner ring and the outer ring formed of the silicon carbide sintered body and the rolling element formed of the alumina sintered body (No. 5-5) is more preferred in the durability to acid and alkali than the rolling bearing having the inner ring, outer ring and rolling element formed of the silicon nitride sintered body (No. 5-7).

Then, the same rolling elements as No. 5-3 (rolling element comprising an alumina sintered body with Young's modulus of 340 GPa, Vickers hardness of 1500), and inner rings and outer rings comprising a plurality of zirconia sintered bodies of different Vickers hardness (inner ring and outer ring comprised of an identical sintered body) were used to prepare test bearings J, and the same test as described above was conducted. Then, the rotation time for each of the test bearings J was converted into a value based on the rotation time of No. 5-7 assumed as “1”, and the value was defined as the durability ratio (rotation life ratio). The result is shown at “a” in the graph of FIG. 18.

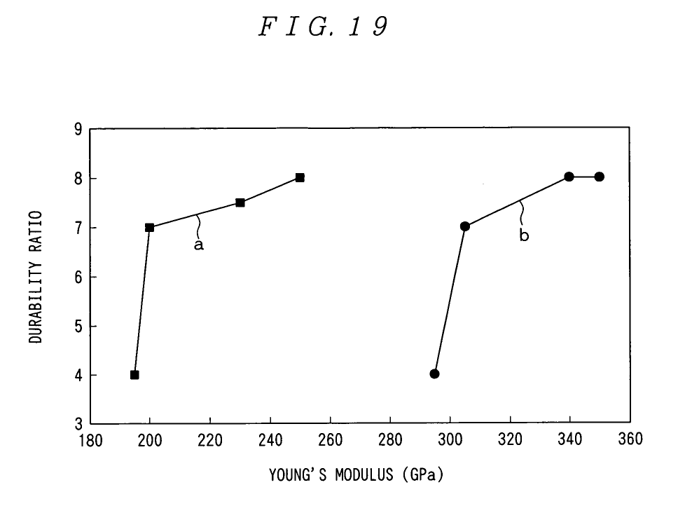

Then, the same rolling elements as No. 5-3 (rolling element comprising an alumina sintered body with Young's modulus of 340 GPa, Vickers hardness of 1500), and inner rings and outer rings comprising a plurality of zirconia sintered bodies of different Young's modulus (inner ring and outer ring comprised of an identical sintered body) were used to prepare test bearings J, and the same test as described above was conducted. Then, the rotation time for each of the test bearings J was converted into a value based on the rotation time of No. 5-7 assumed as “1”, and the value was defined as the durability ratio (rotation life ratio). The result is shown at “a” in the graph of FIG. 19.

Then, the same inner ring and outer ring as No. 5-3 (rolling element comprising a zirconia sintered body with Young's modulus of 200 GPa, Vickers hardness of 1000), and rolling elements comprising a plurality of alumina sintered bodies of different Vickers hardness were used to prepare test bearings J, and the same test as described above was conducted. Then, the rotation time for each of the test bearings J was converted into a value based on the rotation time of No. assumed 5-7 as “1”, and the value was defined as the durability ratio (rotation life ratio). The result is shown at “b” in the graph of FIG. 18.

Then, the same inner ring and outer ring as No. 5-3 (rolling element comprising a zirconia sintered body with Young's modulus of 200 GPa, Vickers hardness of 1000), and rolling elements comprising a plurality of alumina sintered bodies of different Young's modulus were used to prepare test bearings J, and the same test as described above was conducted. Then, the rotation time for each of the test bearings J was converted into a value based on the rotation time of No. 5-7 assumed as “1”, and the value was defined as the durability ratio (rotation life ratio). The result is shown at “b” in the graph of FIG. 19.

As can be seen from both of the figures, the alumina sintered body (●) is remarkably improved in the durability to acid by defining the Young's modulus to 300 or more and Vickers hardness 1500 or more. The zirconia sintered body (▪) is remarkably improved with the durability to acid by defining the Young's modulus to 200 or more and the Vickers hardness 1000 or more.

In each of the embodiments, the cage 4 may also be made of a resin comprising a fluoro resin such as polyphenylene sulfide (PPS) and polytetrafluoroethylene (PTFE), or a resin comprising polyethylene (PE) and the like as a main ingredient, or a synthetic resin blended with the fibrous filler as described above. Further, while a crowned cage was used in each of the embodiments described above, a machined cage may also be used. In this case, an angular type ball bearing is preferred a deep groove type ball bearing considering the assembling of the bearing.

Further, the rolling element comprising the alumina sintered body in the first embodiment can be obtained by primarily molding each alumina material powder by a pelletizing molding method, sintering the same at a sintering temperature from 1400 to 1600° C. and then fabricated to a predetermined accuracy by a lapping board machine.

Further, the present invention is applicable also to other rolling devices than the rolling bearing (for example, linear guide device or ball screw).

TABLE 1

| | | | | | Average | |
|---|---|---|---|---|---|---|
| | | Silicon | | Modulus | crystal | Corro- |
| | Alumina | carbide | Bending | of | grain | sion |
| | content | content | strength | elasticity | size | amount |
| Material | (%) | (%) | (MPa) | (GPa) | (μm) | ratio |
| Silicon | — | 98 | 420 | 580 | — | 0.001 |
| carbide | | | | | | |
| Alumina 1 | 95 | — | 350 | 390 | 40 | 1 |
| Alumina 2 | 99 | — | 500 | 400 | 30 | 0.02 |
| Alumina 3 | 99.5 | — | 400 | 390 | 25 | 0.005 |
| Alumina 4 | 99.5 | — | 320 | 380 | 30 | 0.005 |
| Alumina 5 | 99.9 | — | 590 | 370 | 5 | 0.001 |

TABLE 2

| | | | Number of | |
|---|---|---|---|---|
| | | | alumina | Surface |
| | Inner ring | Rolling | rolling | roughness of |
| | Outer ring | element | element | rolling element |
| No. 1-1 | Silicon carbide | Alumina 1 | 8 | 0.2 |
| No. 1-2 | Silicon carbide | Alumina 2 | 8 | 0.2 |
| No. 1-3 | Silicon carbide | Alumina 3 | 8 | 0.2 |
| No. 1-4 | Silicon carbide | Alumina 4 | 8 | 0.2 |
| No. 1-5 | Silicon carbide | Alumina 5 | 8 | 0.02 |
| No. 1-6 | Silicon carbide | Alumina 5 | 8 | 0.05 |
| No. 1-7 | Silicon carbide | Alumina 5 | 8 | 0.1 |
| No. 1-8 | Silicon carbide | Alumina 5 | 8 | 0.2 |
| No. 1-9 | Silicon carbide | Alumina 5 | 4 | 0.2 |
| No. 1-10 | Silicon carbide | Alumina 5 | 2 | 0.2 |
| No. 1-11 | Silicon carbide | Alumina 5 | 1 | 0.2 |
| No. 1-12 | Silicon carbide | Alumina 5 | 8 | 0.45 |
| No. 1-13 | Silicon carbide | Alumina 5 | 8 | 0.5 |
| No. 1-14 | Silicon carbide | Silicon | 0 | 0.05 |
| | | carbide | | |
| No. 1-15 | Silicon carbide | Silicon | 0 | 0.2 |
| | | carbide | | |
| No. 1-16 | Silicon carbide | Alumina 5 | 8 | 0.01 |
| No. 1-17 | Silicon carbide | Alumina 5 | 8 | 0.55 |

TABLE 3

| | Material powder | | | | Sintered body | | |
|---|---|---|---|---|---|---|---|
| | | Primary | | | | | Average |
| | Alumina | particle | Sintering | | Relative | Alumina | grain |
| | content | size | | Temperature | density | content | size |
| | (%) | (μm) | Method | (° C.) | (%) | (%) | (μm) |
| Silicon | — | — | Pressureless | — | — | — | — |
| carbide | | | sintering | | | | |
| Alumina 6 | 99.9 | 4 | Pressureless | 1600 | 99.0 | 99.5 | 25 |
| | | | sintering | | | | |
| Alumina 7 | 99.9 | 0.5 | Pressureless | 1600 | 99.2 | 99.5 | 6 |
| | | | sintering | | | | |
| Alumina 8 | 99.9 | 0.5 | Pressure | 1600 | 99.5 | 99.5 | 4 |
| | | | sintering | | | | |
| Alumina 9 | 99.99 | 0.1 | Pressure | 1400 | 99.8 | 99.9 | 0.5 |
| | or more | | sintering | | | | |

TABLE 4

| | Inner ring, | |
|---|---|---|
| | outer ring | Rolling element |
| No. 1-18 | Silicon carbide | Alumina 8 |
| No. 1-19 | Silicon carbide | Alumina 9 |
| No. 1-20 | Alumina 9 | Alumina 9 |
| No. 1-21 | Silicon carbide | Silicon carbide |
| No. 1-22 | Silicon carbide | Alumina 6 |
| No. 1-23 | Silicon carbide | Alumina 7 |

TABLE 5

| | Mateial powder | | | Sintered body | | | |
|---|---|---|---|---|---|---|---|
| | | Primary | | | Average | | |
| | | particle | Diameter for 80% | | crystal | | Standard |
| | Alumina | center | accumulated | Alumina | grain | Standard | deviation/ |
| | content | diameter | weight | content | size | deviation | average |
| | (%) | (μm) | (μm) | (%) | (μm) | (μm) | grain size |
| Alumina 11 | >99.99 | 0.2 | 0.4 | >99.99 | 0.5 | 0.1 | 0.2 |
| Alumina 12 | >99.99 | 0.5 | 0.6 | >99.99 | 1.0 | 0.2 | 0.2 |
| Alumina 13 | >99.99 | 0.5 | 0.6 | >99.99 | 1.0 | 0.4 | 0.4 |
| Alumina 14 | >99.99 | 0.5 | 0.6 | >99.99 | 1.8 | 0.4 | 0.2 |
| Alumina 15 | >99.99 | 0.5 | 0.6 | >99.99 | 1.8 | 0.6 | 0.3 |
| Alumina 16 | >99.99 | 0.5 | 0.8 | >99.99 | 1.8 | 0.8 | 0.4 |
| Alumina 17 | >99.99 | 0.5 | 0.8 | >99.99 | 1.8 | 1.0 | 0.6 |
| Alumina 18 | >99.99 | 0.6 | 0.9 | >99.99 | 2.0 | 0.4 | 0.2 |
| Alumina 19 | >99.99 | 0.6 | 0.9 | >99.99 | 3.0 | 0.5 | 0.2 |
| Alumina 20 | >99.99 | 0.8 | 1.2 | >99.99 | 5.0 | 1.2 | 0.2 |
| Alumina 21 | >99.99 | 1.0 | 2.0 | >99.99 | 10.0 | 2.5 | 0.3 |

TABLE 6

| | Inner ring, outer ring | Rolling element |
|---|---|---|
| No. 2-1 | Alumina 11 | Alumina 11 |
| No. 2-2 | Alumina 12 | Alumina 11 |
| No. 2-3 | Alumina 13 | Alumina 11 |
| No. 2-4 | Alumina 14 | Alumina 11 |
| No. 2-5 | Alumina 15 | Alumina 11 |
| No. 2-6 | Alumina 16 | Alumina 11 |
| No. 2-7 | Alumina 17 | Alumina 11 |
| No. 2-8 | Alumina 18 | Alumina 11 |
| No. 2-9 | Alumina 19 | Alumina 11 |
| No. 2-10 | Alumina 20 | Alumina 11 |
| No. 2-11 | Alumina 21 | Alumina 11 |
| No. 2-12 | Zirconia | Alumina 11 |
| No. 2-13 | Zirconia | Alumina 12 |
| No. 2-14 | Zirconia | Alumina 14 |
| No. 2-15 | Zirconia | Alumina 19 |
| No. 2-16 | Zirconia | Alumina 20 |
| No. 2-17 | Silicon carbide | Alumina 11 |
| No. 2-18 | Silicon carbide | Alumina 12 |
| No. 2-19 | Silicon carbide | Alumina 14 |
| No. 2-20 | Silicon carbide | Alumina 19 |
| No. 2-21 | Silicon carbide | Alumina 20 |
| No. 2-22 | PVdF + carbon fiber (15%) | Alumina 11 |
| No. 2-23 | PVdF + carbon fiber (15%) | Alumina 12 |
| No. 2-24 | PVdF + carbon fiber (15%) | Alumina 14 |
| No. 2-25 | PVdF + carbon fiber (15%) | Alumina 19 |
| No. 2-26 | PVdF + carbon fiber (15%) | Alumina 20 |

TABLE 7

| | | | | | | | Total content | | | | | |
|---|---|---|---|---|---|---|---|---|---|---|---|---|
| | | | Sintered | | Linear | | of alkali and | | Plasma | | | |
| | | | body | | transmittance | | alkaline earth | | etching | | Durability | |
| | Material | | purity (%) | | (%) | | metal (ppm) | | Y/N | | ratio | |
| | Inner | | Inner | | Inner | | Inner | | Inner | | | In |
| | ring, | | ring, | | ring, | | ring, | | ring, | | In | Aque- |
| | Outer | Rolling | Outer | Rolling | Outer | Rolling | Outer | Rolling | Outer | Rolling | hydrochloric | ous |
| | ring | element | ring | element | ring | element | Ring | element | ring | element | acid | NaOH |
| No. 3-1 | Al₂O₃ | Al₂O₃ | 99.80 | 99.50 | 0 | 0 | 800 | 1000 | ◯ | ◯ | 3 | 3 |
| No. 3-2 | Al₂O₃ | Al₂O₃ | 99.96 | 99.95 | 35 | 40 | 350 | 400 | X | ◯ | 8 | 8 |
| No. 3-3 | Al₂O₃ | Al₂O₃ | 99.95 | 99.96 | 30 | 40 | 450 | 350 | X | ◯ | 9 | 9 |
| No. 3-4 | Al₂O₃ | Al₂O₃ | 99.97 | 99.98 | 30 | 45 | 300 | 200 | ◯ | ◯ | 10 | 10 |
| No. 3-5 | SiC | Al₂O₃ | — | 99.98 | 0 | 50 | — | 200 | ◯ | ◯ | 7 | 8 |
| No. 3-6 | Al₂O₃ | Al₂O₃ | 99.94 | 99.94 | 20 | 20 | 550 | 550 | ◯ | ◯ | 4 | 4 |
| No. 3-7 | Si₃N₄ | Si₃N₄ | — | — | 0 | 0 | — | — | ◯ | ◯ | 1 | 1 |
| No. 3-8 | Al₂O₃ | Al₂O₃ | 99.40 | 99.30 | 0 | 0 | 1500 | 1800 | ◯ | X | 1.5 | 0.8 |
| No. 3-9 | SiC | SiC | — | — | 0 | 0 | — | — | X | ◯ | 2 | 1 |
| No. 3-10 | Al₂O₃ | Al₂O₃ | 99.95 | 99.96 | 25 | 20 | 400 | 350 | ◯ | ◯ | 5 | 5 |

TABLE 8

| | | | Durability |
|---|---|---|---|
| | Inner ring and outer ring | Rolling element | ratio |
| No. 4-1 | PE | Alumina 8 | 3 |
| No. 4-2 | PEEK | Alumina 9 | 3 |
| No. 4-3 | PVdF + carbon fiber (15%) | Alumina 9 | 8 |
| No. 4-4 | PVdF + potassium titanate | Alumina 8 | 6.5 |
| | whisker (20%) | | |
| No. 4-5 | PEEK + carbon fiber (20%) | Alumina 9 | 4.5 |
| No. 4-6 | PPS + carbon fiber (20%) | Alumina 9 | 7 |
| No. 4-7 | PEN + carbon fiber (15%) | Alumina 9 | 5 |
| No. 4-8 | PEEK | Silicon nitride | 1 |

TABLE 9

| | | | Young's | | Vickers | | | |
|---|---|---|---|---|---|---|---|---|
| | | | modulus | | hardness | | Durability | |
| | Material | | (GPa) | | (Hv) | | ratio | |
| | Inner | Roll- | Inner | Roll- | Inner | Roll- | In | In |
| | ring, | ing | ring, | ing | ring, | ing | hydro- | aque- |
| | outer | ele- | outer | ele- | outer | ele- | chloric | ous |
| | ring | ment | ring | ment | ring | ment | acid | NaOH |
| No. | ZrO₂ | Al₂O₃ | 220 | 310 | 1450 | 1800 | 9 | 9 |
| 5-1 | | | | | | | | |
| No. | ZrO₂ | Al₂O₃ | 250 | 300 | 1050 | 1450 | 6 | 8 |
| 5-2 | | | | | | | | |
| No. | ZrO₂ | Al₂O₃ | 200 | 340 | 1000 | 1500 | 7 | 7 |
| 5-3 | | | | | | | | |
| No. | ZrO₂ | Al₂O₃ | 200 | 310 | 1000 | 1450 | 4 | 5 |
| 5-4 | | | | | | | | |
| No. | SiC | Al₂O₃ | 410 | 410 | 2500 | 1400 | 2 | 4 |
| 5-5 | | | | | | | | |
| No. | ZrO₂ | Al₂O₃ | 210 | 300 | 1000 | 1450 | 3 | 4 |
| 5-6 | | | | | | | | |
| No. | Si₃N₄ | Si₃N₄ | 280 | 280 | 1450 | 1450 | 1 | 1 |
| 5-7 | | | | | | | | |

Industrial Applicability

As has been described above, the rolling device according to the present invention can ensure excellent corrosion resistance and can prevent occurrence of dry friction and the like between a rolling element and a raceway groove even in a case where a slight amount of a solution intrudes to the inside, and can maintain a stable performance for a long time.

Further, when at least the rolling element is constituted with an alumina sintered body obtained by a pressure sintering method and having a relative density of 99.5% or more, the corrosion resistance of the material and the rolling fatigue property can be improved, and stable performance can be maintained for a long time in both acidic and alkaline corrosion circumstances.

Further, a rolling device having excellent wear resistance can be obtained by constituting at least the rolling element with an alumina sintered body with an alumina content of 99.5 mass % or more and an average grain size of a crystal particle of less than 2 μm. Particularly, when an alumina sintered body comprising a crystal particle with an average grain size of less than 2 μm and a ratio of a standard deviation to the average grain size of 0.4 or less is used, a rolling device having more excellent in the wear resistance can be obtained.

Further, when an alumina sintered body with a total content of alkali metal elements and alkaline earth metal element of 500 mass ppm or less and a linear transmittance of a light at wavelength of 650 nm for 1 mm thickness of 30% or more is used at least to the rolling element, a rolling device of particularly excellent durability to halogen gas or ion plasma can be obtained. The rolling device can be used suitably for plasma etching apparatus used in the production of semiconductor devices.

1. A rolling device at least comprising a first member and a second member having raceway grooves opposed to each other, and a plurality of rolling elements arranged rotatably between the raceway grooves of both of the members, in which one of the first member and the second member moves relatively to the other by the rolling of the rolling elements, wherein
the first member, the second member and the plurality of rolling elements are formed of ceramic materials, one or more of the plurality of rolling elements comprise an alumina sintered body with an alumina content of 99.5 mass % or more, and a bending strength of the alumina sintered body by a three point bonding test according to JIS R 1601 of 320 MPa or more.

2. A rolling device according to claim 1, wherein each of the first member and the second member is comprised of a silicon carbide sintered body.

3. A rolling device according to claim 1, wherein each of the first member and the second member is comprised of an alumina sintered body with an alumina content of 99.5 mass % or more and the bending strength of the alumina sintered body by the three point bending test according to JIS-R 1601 is 320 MPa or more.

4. A rolling device according to claim 1, wherein each of the first member and the second member is comprised of a zirconia sintered body.

5. A rolling device at least comprising a first member and a second member having raceway grooves opposed to each other, and a plurality of rolling elements arranged rotatably between the raceway grooves of both of the members, in which one of the first member and the second member moves relatively to the other by the rolling of the rolling elements, wherein
at least one of the first member and the second member is formed of a synthetic resin, and
one or more of the plurality of rolling elements comprises an alumina sintered body with an alumina content of 99.5 mass % or more, and a bending strength of the alumina sintered body by a three point bonding test according to JIS R 1601 of 320 MPa or more.

6. A rolling device according to claim 1 or 5, wherein all of the plurality of rolling elements are comprised of an alumina sintered body with alumina content of 99.5 mass % or more and the bending strength of the alumina sintered body by the three point bending test according to JIS-R 1601 of 320 MPa or more.

7. A rolling device according to any one of claims 1, 3 and 5, wherein the average grain size of a crystal particle constituting the alumina sintered body is less than 2 μm.

8. A rolling device according to any one of claims 1, 3 and 5, wherein the average grain size of a crystal particle constituting the alumina sintered body is less than 2 μm, and a ratio of the standard deviation to the average grain size is 0.4 or less.

9. A rolling device according to claim 1 or 5, wherein the surface roughness of the rolling element comprising the alumina sintered body is 0.02 μm or more and 0.5 μm or less as the center line mean roughness (Ra).

10. A rolling device according to any one of claims 1, 3 and 5, wherein the alumina sintered body is obtained by a pressure sintering method and has a relative density of 99.5% or more.

11. A rolling device according to any one of claims 1, 3 and 5, wherein the alumina sintered body has a total content for alkali metal elements and alkaline earth elements of 500 mass ppm or less and a linear transmittance of a light at a wavelength of 650 nm for 1 mm thickness of 30% or more.
